(19) United States
(12) Patent Application Publication
(10) Pub. No.: US 2024/0152039 A1
(43) Pub. Date: May 9, 2024

(54) PROJECTION SYSTEM

(71) Applicant: GUANGZHOU LUXVISIONS INNOVATION TECHNOLOGY LIMITED, GUANGZHOU (CN)

(72) Inventor: Chuan-Hui Liu, Guangzhou (CN)

(73) Assignee: GUANGZHOU LUXVISIONS INNOVATION TECHNOLOGY LIMITED, GUANGZHOU (CN)

(21) Appl. No.: 18/171,374

(22) Filed: Feb. 20, 2023

(30) Foreign Application Priority Data
Nov. 8, 2022 (CN) 202211393206.6

(51) Int. Cl. G03B 21/00; G03B 21/20

(52) U.S. Cl. CPC G03B 21/006; G03B 21/2033; G03B 21/2066; G03B 21/2073; G03B 21/208; G02B 3/0056

(57) ABSTRACT

A projection system is provided, including: a light source, a liquid crystal panel, an illuminating lens group, an imaging lens group and an aperture. The light source is used to emit an illuminating beam, and enters the liquid crystal panel through the illuminating lens group. The liquid crystal panel is used to receive the illuminating beam and convert the illuminating beam into an image beam, and the image beam passes through the imaging lens group and exits the projection system through the aperture. The illuminating lens group includes a collimating lens group, a fly-eye lens, a relay lens, a linear polarizer, a polarized beam splitter, and a condenser lens in sequence. The imaging lens group includes the condenser, the polarized beam splitter, a quarter wave plate, a spherical lens, the quarter wave plate, and the polarized beam splitter in sequence, and the projection system is exit through the aperture.

### CROSS-REFERENCE TO RELATED APPLICATION

This application claims the priority benefit of China application serial no. 202211393206.6, filed on Nov. 8, 2022. The entirety of the above-mentioned patent application is hereby incorporated by reference herein and made a part of this specification.

### BACKGROUND

### Technical Field

The disclosure relates to a projection system.

### Description of Related Art

Compared with traditional bulky projectors, micro projectors have advantages such as high brightness and small size, therefore they have wide application potential, such as being used in external micro projectors or integrated in head-mounted display devices, such as augmented reality (AR) glasses. By further reducing the volume of the micro projector, the convenience and comfort level of the user may be effectively improved.

### SUMMARY

An embodiment of the disclosure provides a projection system, including a light source, a liquid crystal panel, an illuminating lens group, an imaging lens group, and an aperture. The light source is used to emit an illuminating beam, which enters the liquid crystal panel through the illuminating lens group. The liquid crystal panel is used to receive the illuminating beam and convert the illuminating beam into an image beam. The image beam passes through the aperture and exits the projection system after passing through the imaging lens group. The illuminating lens group includes a collimating lens group, a fly-eye lens, a relay lens, a linear polarizer, a polarized beam splitter, and a condenser lens in sequence. The imaging lens group includes a condenser lens, the polarized beam splitter, a quarter wave plate, a spherical reflector, the quarter wave plate, and the polarized beam splitter in sequence. The projection system is exit through the aperture.

According to some embodiments of the disclosure, the light source is a matrix light-emitting diode.

According to some embodiments of the disclosure, the collimating lens group is an aspherical lens.

According to some embodiments of the disclosure, the collimating lens group includes two lenses, in which a diopter of the two lenses are positive, and the two lenses are plano-convex lenses.

According to some embodiments of the disclosure, the fly-eye lens is a plastic lens.

According to some embodiments of the disclosure, the refractive index of the fly-eye lens is 1.4 to 1.6.

According to some embodiments of the disclosure, the fly-eye lens has multiple microstructure units, and each of the microstructure units is a rectangular spherical lens.

According to some embodiments of the disclosure, the projection system satisfies 1≤aspect ratio of the rectangular spherical lens <aspect ratio of the liquid crystal panel.

According to some embodiments of the disclosure, the projection system satisfies that a thickness of the fly-eye lens=an effective focal length of the microstructure unit*a refractive index of the fly-eye lens.

According to some embodiments of the disclosure, the projection system satisfies 100<number of fly-eye lens microstructure units <125.

According to some embodiments of the disclosure, the relay lens has a positive diopter.

According to some embodiments of the disclosure, the relay lens is a plano-convex lens.

According to some embodiments of the disclosure, the condenser lens has a positive diopter.

According to some embodiments of the disclosure, the condenser lens is a double-sided aspherical lens.

According to some embodiments of the disclosure, the spherical reflector is a plano-convex lens, and a reflective surface of the plano-convex lens is coated with a high reflection coating.

According to some embodiments of the disclosure, the projection system satisfies 10 mm <system length<30 mm, in which the system length is a distance from a light-incident surface of the collimating lens group to the aperture.

According to some embodiments of the disclosure, a dimension of the aperture is 3 mm to 4 mm.

According to some embodiments of the disclosure, the projection system satisfies |effective focal length of the imaging lens group|≤|effective focal length of the illuminating lens group|.

In the projection system described in the embodiment of the disclosure, by sharing a portion of the optical elements among an illuminating light path and an imaging light path in the projection system, the volume of the projection system may be effectively reduced and the production cost may be reduced.

### BRIEF DESCRIPTION OF THE DRAWINGS

FIG. 1 is a schematic diagram of a projection system according to an embodiment of the disclosure.

FIG. 2 is a schematic diagram of a fly-eye lens according to an embodiment of the disclosure.

FIG. 3A and FIG. 3B are aberration curves of the projection system shown in FIG. 1.

FIG. 4 is a schematic diagram of a projection system according to another embodiment of the disclosure.

FIG. 5 is a schematic diagram of a projection system according to another embodiment of the disclosure.

### DETAILED DESCRIPTION OF DISCLOSED EMBODIMENTS

The following examples are described in detail with the accompanying drawings, but the provided examples are not intended to limit the scope of the disclosure. In addition, the dimensions of the elements in the drawings are drawn for the convenience of description, and do not represent the actual proportions of the dimensions of the elements. Also, although terms such as “first”, “second”, etc. are used herein to describe various elements and/or layers, these elements and/or layers should not be limited by these terms. Rather, these terms are only used to distinguish one element or layer from another element or layer. Thus, a first element or film layer discussed below may be referred to as a second element or film layer without departing from the teachings herein. In order to facilitate understanding, similar elements in the following description are described with the same symbols.

Different examples in the description of the embodiments of the disclosure may use repeated reference symbols and/or words. These repeated symbols or words are used for the purpose of simplification and clarity, and are not used to limit the relationship between various embodiments and/or the described appearance structures. Furthermore, if the following disclosure of this specification describes that a first feature is formed on or above a second feature, it means that it includes the embodiment in which the first feature and the second feature are formed in direct contact, also includes an embodiment in which an additional feature is formed between the first feature and the second feature, so that the first feature and the second feature may not be in direct contact. In order to facilitate understanding, similar elements in the following description are described with the same symbols.

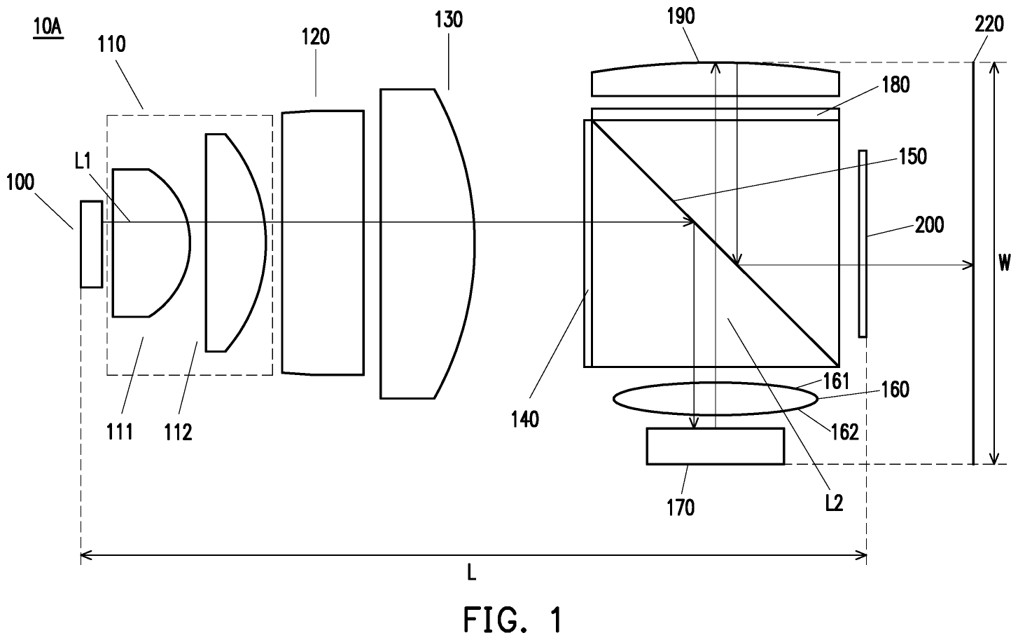

FIG. 1 is a schematic diagram of a projection system according to an embodiment of the disclosure. Referring to FIG. 1, a projection system 10A includes a light source 100, a liquid crystal panel 170, an illuminating lens group, an imaging lens group, and an aperture 200.

The light path of the projection system 10A is as follows: the light source 100 is used to emit the illuminating beam L1, which enters the liquid crystal panel 170 through the illumination lens assembly. The liquid crystal panel 170 is used to receive the illuminating beam L1 and convert the illuminating beam L1 into an image beam L2. The image beam L2 emitted by the liquid crystal panel 170 passes through the imaging lens group, passes through the aperture 200, exits the projection system 10A, and is projected onto the projection surface 220.

Therefore, the projection system 10A may be divided into two parts according to the light path: the illuminating light path from the light source 100 to the liquid crystal panel 170 through the illuminating lens group, and the imaging light path from the liquid crystal panel to the aperture 200 through the imaging lens group. The illuminating light path and the imaging light path are described respectively below.

The light source 100 is used to emit an illuminating beam L1. In some embodiments, the light source 100 is used to simultaneously emit multiple colored lights with different wavelengths. In some embodiments, the light source 100 may simultaneously emit colored lights of more than three wavelengths, for example, the colored lights with wavelengths of 624 nm, 522 nm, and 455 nm, but the disclosure is not limited thereto. In some embodiments, the light source 100 may be an RGGB matrix light-emitting diode for respectively emitting red light, green light, and blue light. Each RGGB matrix light-emitting diode unit includes four light-emitting diodes, including a red light-emitting diode, two green light-emitting diodes, and a blue light-emitting diode. That is, the number of red light-emitting diodes, green light-emitting diodes, and blue light-emitting diodes is 1:2:1. In other embodiments, the light source 100 may also be an organic light-emitting diode, a quantum dot light source or other light sources with similar properties, the disclosure is not limited thereto.

The illuminating beam emitted by the light source 100 enters the illuminating lens group, and finally enters the liquid crystal panel 170. As shown in FIG. 1, the illuminating lens group includes a collimating lens group 110, a fly-eye lens 120, a relay lens 130, a linear polarizer 140, a polarized beam splitter 150, and a condenser lens 160 in sequence.

The collimating lens group 110 includes two lenses 111 and 112, the diopters of the two lenses, namely the lens 111 and the lens 112, are both positive, and both the lens 111 and the lens 112 are plano-convex lenses. In this embodiment, the light-incident surfaces of the lens 111 and the lens 112 are flat planes, and the light-exit surfaces are aspherical. Through the combination of the lens 111 and the lens 112, the collimating lens 110 is used to collimate the illuminating beam L1 emitted by the light source 100 to enter the fly-eye lens 120.

The illuminating beam L1 collimated by the collimating lens 110 enters the fly-eye lens 120. The fly-eye lens 120 is used to redistribute the incident collimated illuminating beam L1 to achieve a uniform light source.

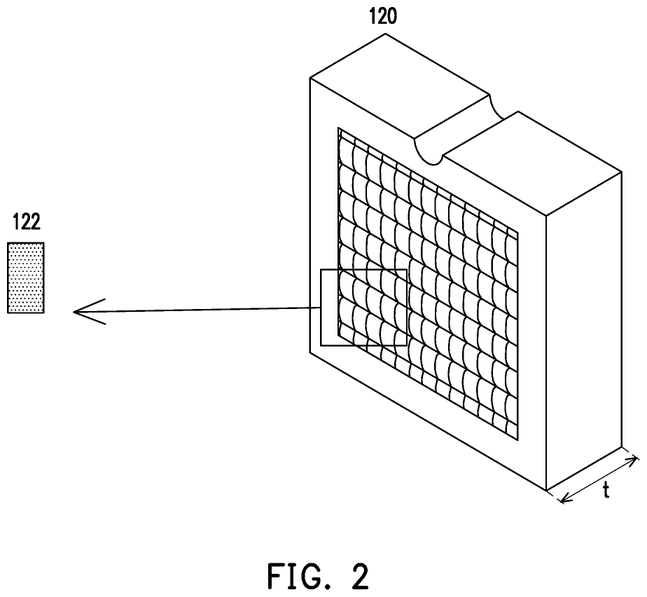

Please refer to FIG. 2 for the structure of the fly-eye lens 120. FIG. 2 is a schematic diagram of a fly-eye lens according to an embodiment of the disclosure. The fly-eye lens 120 has multiple microstructure units 122. In some embodiments, each of the microstructure units 122 is a rectangular spherical lens, which is used to redistribute the collimated illuminating beam L1 entering from the collimating lens 110, so as to improve the utilization rate of the illuminating beam L1 such that the illuminating beam L1 produces a uniform distribution over a large area.

When the illuminating beam L1 enters the fly-eye lens 120, the illuminating beam L1 enters the microstructure units 122 of the fly-eye lens 120 at the same time. In this embodiment, since each of the microstructure units 122 is a rectangular spherical lens, the illuminating beam L1 incident on the microstructure unit 122 may respectively form a rectangular light spot. After being superimposed, the rectangular light spots formed by all the microstructure units 122 are superimposed in the same field of view to form a rectangular illuminating beam with uniform brightness. Thus, the fly-eye lens 120 may be used to convert the illuminating beam L1 into a rectangular illuminating beam with uniform brightness.

The shape of the illuminating beam L1 may be controlled through the distribution and the number of the microstructure units 122. In other words, the number and distribution of the microstructure units 122 may be determined according to actual requirements. According to some embodiments, the microstructure units of the fly-eye lens 120 are distributed in a rectangular shape, but the disclosure is not limited thereto. According to some embodiments, the number of microstructure units 122 of the fly-eye lens 120 satisfies the following relationship: 100<the number of microstructure units 122 of the fly-eye lens 120<125, but there may also be different numbers according to actual requirements, and this disclosure is not limited thereto.

In some embodiments, the fly-eye lens 120 may be a plastic lens or a material with similar properties to reduce the weight of the system. In some embodiments, the refractive index of the fly-eye lens 120 is 1.4 to 1.6, but may also have different refractive indices according to actual application requirements, and the disclosure is not limited thereto.

In some embodiments, the thickness t of the fly-eye lens 120 satisfies the following relationship: thickness t of the fly-eye lens 120=effective focal length of the microstructure unit 122*refractive index of the fly-eye lens 120.

Referring to FIG. 1 again, after the illuminating beam L1 exits the fly-eye lens 120, it enters the relay lens 130. In this embodiment, the relay lens 130 has a positive diopter, and the relay lens 130 is a plano-convex lens. The relay lens 130 is used to converge the illuminating beam L1 to enter the linear polarizer 140.

The illuminating beam L1 enters the linear polarizer 140 through the relay lens 130. The colored light generated by the light source 100 has no specific polarization direction. When the illuminating beam L1 enters the linear polarizer 140, the linear polarizer 140 turns the polarization direction of the illuminating beam L1 into S polarization, which enters the polarized beam splitter 150.

The polarized beam splitter 150 (PBS) may reflect the incident light with S polarization, or allow the incident light with P polarization to pass through. Since the incident illuminating beam L1 is incident light with S polarization when passing through the linear polarizer 140, the polarized beam splitter 150 reflects the illuminating beam L1 and enters the condenser lens 160.

The condenser lens 160 is used for converging the incident illuminating beam L1, so that the converging illuminating beam L1 enters the liquid crystal panel 170. In this embodiment, the condenser lens 160 has a positive diopter. In this embodiment, the condenser lens 160 is a double-sided aspherical lens, that is, both surfaces of the condenser lens 160 are aspherical surfaces, in which the two surfaces are respectively different aspherical surfaces.

In this embodiment, the surfaces 161 and 162 of the condenser lens 160 are both aspherical surfaces, and these aspherical surfaces are defined according to the following Formula (1):

$$Z ( Y ) = \frac{{Y}^{2}}{R} / ( 1 + \sqrt{1 - ( 1 + K ) \frac{{Y}^{2}}{{R}^{2}}} ) + {\sum }_{i = 1}^{n} {a}_{2 i} \times {Y}^{2 i} \qquad ( 1 )$$

Y: the distance between a point on the aspheric curve and the optical axis I.
Z: the depth of the aspherical surface, that is, the vertical distance between the point on the aspherical surface whose distance from the optical axis I is Y, and the tangent plane that is tangent to the apex of the aspherical surface on the optical axis.
R: the radius of curvature of the lens surface.
K: the conical coefficient.
a₂ᵢ: the 2i^{th} order aspheric coefficient.

The various aspheric coefficients of the above-mentioned aspherical surface in Formula (1) are shown in Table 1 below. The row number 161 in Table 1 indicates that it is the aspheric coefficient of the surface 161 of the condenser lens 160, and the row number 162 indicates that it is the aspherical surface coefficient of the surface 162 of the condenser lens 160.

TABLE 1

| Side | K | a₄ | a₆ | a₈ | a₁₀ | a₁₂ |
|---|---|---|---|---|---|---|
| 161 | 1.55E+01 | 4.05E−03 | −6.08E−04 | 8.84E−05 | −5.72E−06 | 1.41E−7 |
| 162 | 0-6.96E+00 | 7.22E−03 | −7.93E−04 | 1.04E−04 | −6.58E−06 | 1.60E−7 |

The illuminating beam L1 enters the liquid crystal panel 170 through the condenser lens 160. In this embodiment, the liquid crystal panel 170 is a liquid crystal on silicon (LCOS) panel. By applying an appropriate voltage to the liquid crystal panel 170, the degree of reflection of each graphic element in the liquid crystal panel 170 on the illuminating beam L1 may be controlled, so as to generate an image beam L2, thereby achieving the effect of image control.

In this embodiment, the liquid crystal panel 170 is rectangular. When the illuminating beam L1 passes through the fly-eye lens 120, the illuminating beam L1 passes through the microstructure unit 122 of the fly-eye lens 120 to shape the illuminating beam L1 into a rectangular illuminating beam L1 in cross section. In order to improve the efficiency of the liquid crystal panel 170 receiving the illuminating beam L1, the projection system 10A satisfies the following condition, that is, 1≤aspect ratio of the microstructure unit (i.e., rectangular spherical lens) 122≤aspect ratio of the liquid crystal panel 170. According to this condition, the aspect ratio of the section of the illuminating beam L1 may be equal to or smaller than that of the liquid crystal panel 170 to improve the efficiency of the liquid crystal panel 170 receiving the illuminating beam L1. On the other hand, when the illuminating beam L1 with S polarization enters the liquid crystal panel 170, the liquid crystal panel 170 changes the polarization direction of the illuminating beam L1, so that the polarization direction of the image beam L2 emitted by the liquid crystal panel 170 is changed from the original S polarization of the illuminating beam L1 to P polarization.

The image beam L2 emitted by the liquid crystal panel 170 enters the illuminating lens group, finally exits the projection system 10A through the aperture 200, and is projected onto the projection surface 220. As shown in FIG. 1, the imaging lens group includes a condenser lens 160, a polarized beam splitter 150, a quarter wave plate 180, a spherical reflector 190, a quarter wave plate 180, and a polarized beam splitter 150 in sequence.

The image beam L2 emitted by the liquid crystal panel 170 enters the polarized beam splitter 150 through the condenser lens 160. Since the polarization direction of the image beam L2 is P polarization, the image beam L2 may pass through the polarized beam splitter 150.

The image beam L2 passing through the polarized beam splitter 150 enters the quarter wave plate 180. When the image beam L2 passes through the quarter wave plate 180, the phase of the image beam L2 is delayed by π/4, which is equivalent to delaying the phase by ¼ wavelength.

The image beam L2 passing through the quarter wave plate 180 enters the spherical reflector 190. In this embodiment, the spherical reflector 190 is a plano-convex lens, and the reflective surface of the plano-convex lens, that is, the convex surface, is coated with a high reflection coating for reflecting the image beam L2.

The image beam L2 reflected by the spherical reflector 190 enters the quarter wave plate 180 again. At this time, the phase of the image beam L2 passing through the quarter wave plate 180 is delayed by π/4 again, which is equivalent to delaying the phase by ¼ wavelength. Therefore, the phase of the image beam passing through the quarter wave plate 180 twice is equivalent to being delayed by π/2 in total, which is equivalent to delaying the phase by ½ wavelength. At this time, the original image beam L2 with P polarization emitted by the liquid crystal panel 170 becomes the image beam L2 with S polarization after passing through the quarter wave plate 180 twice.

When the image beam with S polarization enters the polarized beam splitter 150, the polarized beam splitter 150 reflects the image beam L2, such that the image beam enters the aperture 200, exits the projection system 10A, and is projected onto the projection surface 220. In this embodiment, the dimension of the aperture 200 is 3 to 4 mm.

Therefore, as shown in FIG. 1, the condenser lens 160 and the spherical reflector 190 project the image beam L2 emitted by the liquid crystal panel 170 onto the projection surface.

In the projection system 10A, the illuminating light path and the imaging light path share some optical elements, including the polarized beam splitter 150 and the condenser lens 160, therefore, the light path is effectively shortened, thereby reducing the length and volume of the projection system 10. In this embodiment, the projection system 10A satisfies 10 mm<system length<30 mm, in which the system length is the distance from the light-incident surface of the collimating lens group 110 to the aperture 200.

In addition, in this embodiment, the projection system 10A satisfies the following relationship: |effective focal length of the imaging lens group|≤|effective focal length of the illuminating lens group|.

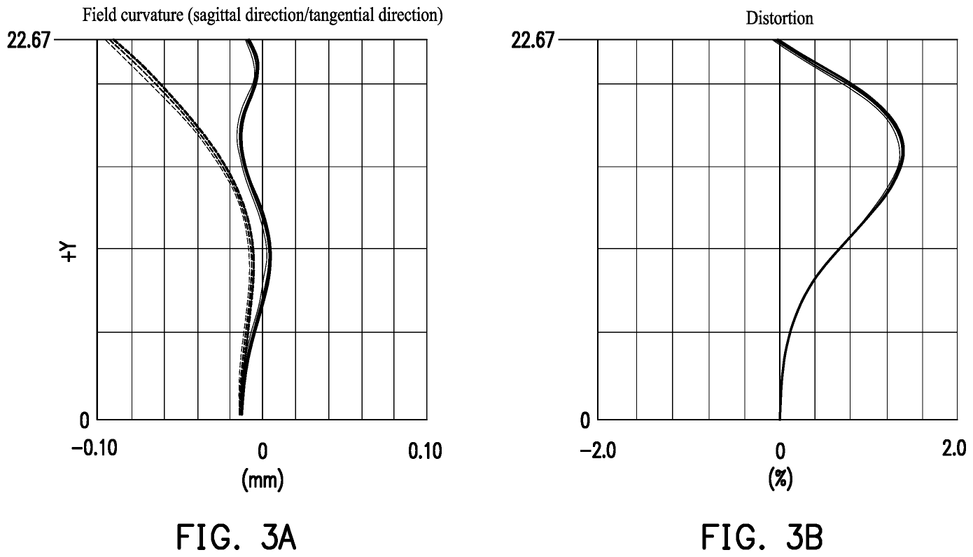

FIG. 3A and FIG. 3B are aberration curves of the projection system shown in FIG. 1. Referring to FIG. 3A to FIG. 3B, the diagram in FIG. 3A shows the field curvature aberration in the sagittal direction (dashed line) and the field curvature aberration in the tangential direction (solid line) on the imaging surface when the light wavelength is 656 nm, 587 nm, and 486 nm, and the diagram in FIG. 3B shows the distortion aberration on the projection plane 220 when the light wavelength is 656 nm, 587 nm, and 486 nm.

In the two field curvature aberration diagrams in FIG. 3A, the field curvature aberrations of the above three representative wavelengths in the entire field of view fall within ±0.1 mm, indicating that the optical system of this embodiment may effectively eliminate aberrations. The distortion aberration diagram in FIG. 3B shows that the distortion aberration of this embodiment is maintained within the range of ±2%, indicating that the distortion aberration of this embodiment meets the imaging quality requirements of an optical system and may provide good imaging quality.

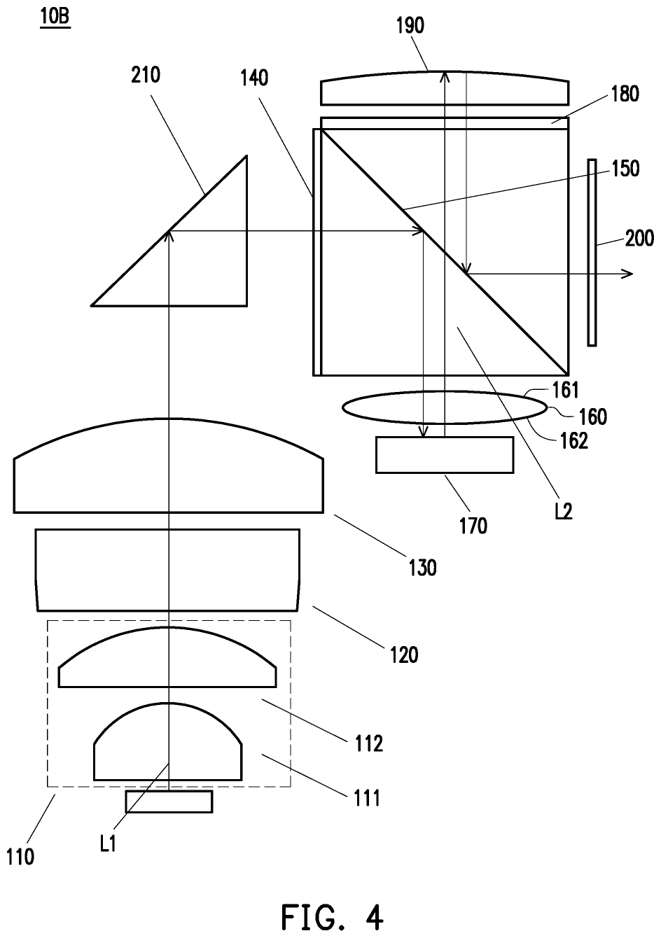

FIG. 4 is a schematic diagram of a projection system according to another embodiment of the disclosure. The projection system 10B shown in FIG. 4 is similar to the projection system 10A shown in FIG. 1, so similar portions are not repeated herein. The difference is that in FIG. 4 there is a prism 210 located between the relay lens 130 and the linear polarizer 140. The illuminating beam L1 exiting the relay lens 130 enters the prism 210, is reflected by the prism 210, and then enters the polarizer 140 in an exiting direction different from the incident direction. Therefore, by disposing the prism 210 in the illuminating light path, the direction of the illuminating light path may be changed, thereby changing the aspect ratio of the projection system. In addition, the light path of the illuminating beam L1 may be rotated to any angle through the prism 210 to meet the requirements of practical applications.

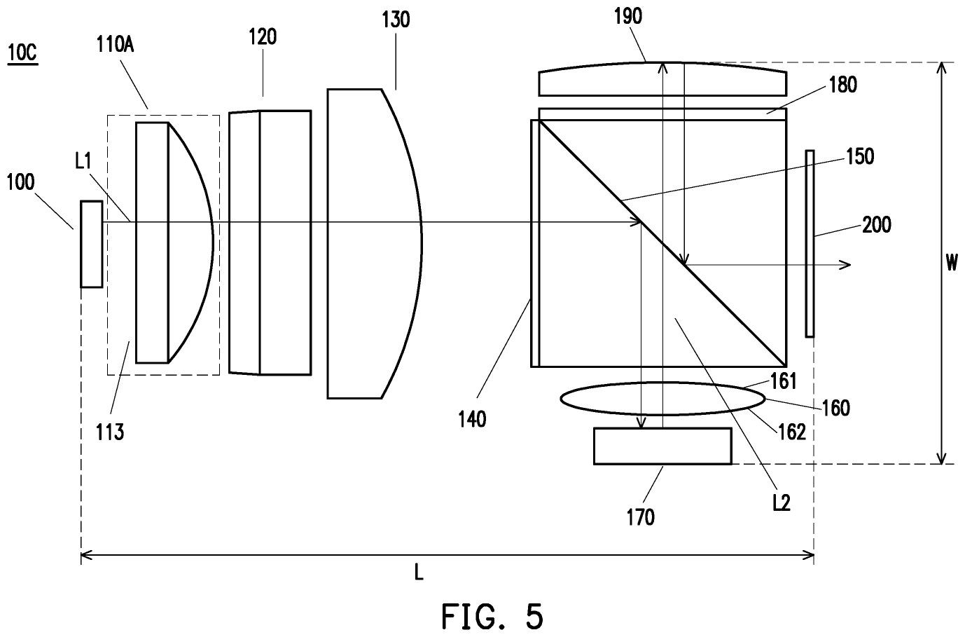

FIG. 5 is a schematic diagram of a projection system according to another embodiment of the disclosure. The projection system 10C shown in FIG. 5 is similar to the projection system 10A shown in FIG. 1, so similar portions are not repeated herein. The difference is that, compared with the collimating lens group 110 in FIG. 1, the collimating lens group 110A in FIG. 5 has only one lens 113. In this embodiment, the lens 113 of the collimating lens group 110A is an aspherical lens, in which the light-incident surface is a flat plane, and the light-exit surface is aspherical. In some embodiments, the diopter of the lens 113 is positive. In some embodiments, the lens 113 is a plano-convex lens. By reducing the number of lenses in the collimating lens group 110A, the illuminating light path may be further shortened, thereby reducing the total length of the projection system.

In the projection system described in the embodiment of the disclosure, by sharing a portion of the optical elements among an illuminating light path and an imaging light path in the projection system, the volume of the projection system may be effectively reduced and the production cost may be reduced.

Although the disclosure has been described in detail with reference to the above embodiments, they are not intended to limit the disclosure. Those skilled in the art should understand that it is possible to make changes and modifications without departing from the spirit and scope of the disclosure. Therefore, the protection scope of the disclosure shall be defined by the following claims.

What is claimed is:

1. A projection system, comprising:
a light source, a liquid crystal panel, an illuminating lens group, an imaging lens group, and an aperture, wherein
the light source, used to emit an illuminating beam and enter the liquid crystal panel through the illuminating lens group,
the liquid crystal panel, used to receive the illuminating beam and convert the illuminating beam into an image beam, wherein the image beam passes through the imaging lens group, passes through the aperture, and exits the projection system,
wherein the illuminating lens group comprises a collimating lens group, a fly-eye lens, a relay lens, a linear polarizer, a polarized beam splitter, and a condenser lens in sequence,
wherein the imaging lens group comprises the condenser lens, the polarized beam splitter, a quarter wave plate, a spherical reflector, the quarter wave plate, and the polarized beam splitter in sequence, and the projection system is exit through the aperture.

2. The projection system according to claim 1, wherein the light source is a matrix light-emitting diode.

3. The projection system according to claim 1, wherein the collimating lens group is an aspherical lens.

4. The projection system according to claim 3, wherein the collimating lens group comprises two lenses, wherein a diopter of the two lenses are positive, and the two lenses are plano-convex lenses.

5. The projection system according to claim 1, wherein the fly-eye lens is a plastic lens.

6. The projection system according to claim 1, wherein a refractive index of the fly-eye lens is 1.4 to 1.6.

7. The projection system according to claim 1, wherein the fly-eye lens has a plurality of microstructure units, and each of the microstructure units is a rectangular spherical lens.

8. The projection system according to claim 7, wherein the projection system satisfies 1≤aspect ratio of the rectangular spherical lens≤aspect ratio of the liquid crystal panel.

9. The projection system according to claim 7, wherein the projection system satisfies that a thickness of the fly-eye lens=an effective focal length of the microstructure units*a refractive index of the fly-eye lens.

10. The projection system according to claim 7, wherein the projection system satisfies 100<number of microstructure units of the fly-eye lens<125.

11. The projection system according to claim 1, wherein the relay lens has a positive diopter.

12. The projection system according to claim 1, wherein the relay lens is a plano-convex lens.

13. The projection system according to claim 1, wherein the condenser lens has a positive diopter.

14. The projection system according to claim 1, wherein the condenser lens is a double-sided aspherical lens.

15. The projection system according to claim 1, wherein the spherical reflector is a plano-convex lens, and a reflective surface of the plano-convex lens is coated with a high reflection coating.

16. The projection system according to claim 1, wherein the projection system satisfies 10 mm<system length<30 mm, wherein the system length is a distance from a light-incident surface of the collimating lens group to the aperture.

17. The projection system according to claim 1, wherein a dimension of the aperture is 3 mm to 4 mm.

18. The projection system according to claim 1, wherein the projection system satisfies |an effective focal length of the imaging lens group|≤|an effective focal length of the illuminating lens group|.
